(19) United States
(12) Patent Application Publication
(10) Pub. No.: US 2025/0367846 A1
(43) Pub. Date: Dec. 4, 2025

(54) MULTI-AXIS ROBOTIC CUTTING MACHINE

(71) Applicant: University of Virginia Patent Foundation, Charlottesville, VA (US)

(72) Inventors: Kyle Schumann, Charlottesville, VA (US); Katherine MacDonald, Charlottesville, VA (US); Gavin T. Garner, Charlottesville, VA (US)

(21) Appl. No.: 19/221,934

(22) Filed: May 29, 2025

Related U.S. Application Data
(60) Provisional application No. 63/653,703, filed on May 30, 2024.

(51) Int. Cl. B27B 13/04; B27B 13/06

(52) U.S. Cl. CPC B27B 13/04; B27B 13/06

(57) ABSTRACT

A multi-axis robotic cutting apparatus is provided and includes a blade, a blade driver supportive of the blade to execute blade driving to drive the blade in a cutting motion along a cutting axis relative to a medium, first and second drive systems to move at least the blade in first and second transverse axes, respectively, relative to the medium during the blade driving, a third drive system to rotate at least the medium about a rotational axis relative to the blade during the blade driving and a fourth drive system to drive an angling of the blade relative to the cutting axis during the blade driving.

### CROSS-REFERENCE TO RELATED APPLICATIONS

This application claims the benefit of priority to provisional application 63/653,703, which was filed on May 30, 2024. The entire contents of provisional application 63/653,703 are incorporated herein by reference.

### BACKGROUND

The present disclosure relates to cutting machines and, in particular, to a multi-axis robotic cutting machine.

Cutting machines, such as sawmills, rely on linear cutting mechanisms to produce standardized components, which often result in material waste and limit the ability to create non-standard geometries. Recent advancements in robotic fabrication and computer numerical control (CNC) technologies have opened new possibilities for milling workpieces into customized timber components with complex geometries.

Despite these advancements, existing robotic systems, such as industrial robotic arms, face limitations in accessibility, cost and operational complexity due to requirements of significant investment in infrastructure, specialized programming knowledge and controlled environments, making them impractical for widespread use. Furthermore, even when paired with robotics, traditional designs lack the capability to produce non-planar components efficiently, which are increasingly in demand for bespoke architectural and construction applications.

### SUMMARY

According to an aspect of the disclosure, a multi-axis robotic cutting apparatus is provided and includes a blade, a blade driver supportive of the blade to execute blade driving to drive the blade in a cutting motion along a cutting axis relative to a medium, first and second drive systems to move at least the blade in first and second transverse axes, respectively, relative to the medium during the blade driving, a third drive system to rotate at least the medium about a rotational axis relative to the blade during the blade driving and a fourth drive system to drive an angling of the blade relative to the cutting axis during the blade driving.

In accordance with at least one or more additional and/or alternative embodiments, the blade is a continuous bandsaw and the medium is wood or lumber.

In accordance with at least one or more additional and/or alternative embodiments, the first and second transverse axes are transverse relative to the cutting axis and the rotational axis is parallel with the first axis.

In accordance with at least one or more additional and/or alternative embodiments, opposite sides of the blade are defined at opposite sides of the medium, respectively, and the fourth drive system drives an angling of the opposite sides of the blade in concert to impart a flat angling to the blade at points of contact with the medium or drives the angling of the opposite sides of the blade to resist imparting the flat angling to the blade at the points of contact with the medium.

In accordance with at least one or more additional and/or alternative embodiments, opposite sides of the blade are defined at opposite sides of the medium, respectively, and the fourth drive system drives an independent angling of the opposite sides of the blade to impart a twist to the blade at points of contact with the medium or drives the independent angling of the opposite sides of the blade to resist imparting the twist to the blade at the points of contact with the medium.

In accordance with at least one or more additional and/or alternative embodiments, opposite sides of the blade are defined at opposite sides of the medium, respectively, and the fourth drive system include driving units at each of the opposite sides of the blade and each of the driving units include a set of bearings to supportively bear upon the blade, a power generating element to generate torque for pivoting the set of bearings about the cutting axis and a gear train by which the torque is transferred from the power generating element to the set of bearings to pivot the bearings about the cutting axis.

In accordance with at least one or more additional and/or alternative embodiments, opposite sides of the blade are defined at opposite sides of the medium, respectively, and the fourth drive system includes driving units at each of the opposite sides of the blade and each of the driving units includes a set of bearings to supportively bear upon the blade, a power generating element to generate torque for pivoting the set of bearings about the cutting axis and a telescopic arm connected at opposite ends thereof to the power generating element and the set of bearings and by which the torque is transferred from the power generating element to the set of bearings to pivot the bearings about the cutting axis.

In accordance with at least one or more additional and/or alternative embodiments, wherein the telescopic arm is configured to telescopically extend and retract the bearings toward and away from the medium.

In accordance with at least one or more additional and/or alternative embodiments, the multi-axis robotic cutting apparatus further includes a control system, the control system including sensors configured to sense relative positions of the blade and the medium in real-time and a processing unit operably coupled with the sensors, the blade driver and the first-fourth drive systems, the processing unit being configured to receive information relating to the relative positions of the blade and the medium from the sensors and to control the blade driver and the first-fourth drive systems in accordance with the information and a predefined cutting pattern.

According to an aspect of the disclosure, a drive system for controlling a blade of a multi-axis robotic cutting apparatus is provided and includes driving units at opposite sides of the blade defined along a cutting axis thereof. Each driving unit includes a mounting bracket by which the driving unit is connected with the multi-axis robotic cutting apparatus, upper and lower roller bearings, a rigid member to tightly urge the upper and lower roller bearings against upper and lower surfaces of the blade, respectively, and a power generating element to generate torque for pivoting the rigid member and the upper and lower roller bearings about the cutting axis and relative to the mounting bracket.

In accordance with at least one or more additional and/or alternative embodiments, the blade is a continuous bandsaw.

In accordance with at least one or more additional and/or alternative embodiments, each driving unit further includes a hollow, C-shaped gear with a slot and an adjustable bearing for receiving and centering the blade.

In accordance with at least one or more additional and/or alternative embodiments, each driving unit further includes a gear train by which the torque is transferred from the power generating element to the rigid member and the upper and lower roller bearings.

In accordance with at least one or more additional and/or alternative embodiments, each driving unit further includes a telescopic arm connected at opposite ends thereof to the power generating element and the rigid member and by which the torque is transferred from the power generating element to the rigid member and the upper and lower roller bearings.

In accordance with at least one or more additional and/or alternative embodiments, the telescopic arm is configured to telescopically extend and retract the rigid member and the upper and lower roller bearings along the cutting axis.

According to an aspect of the disclosure, a method of operating a multi-axis robotic cutting apparatus is provided and includes executing blade driving to drive a blade in a cutting motion along a cutting axis relative to a medium, moving at least the blade in first and second transverse axes, respectively, relative to the medium during the blade driving, rotating at least the medium about a rotational axis relative to the blade during the blade driving and driving an angling of opposite sides of the blade, which are defined at opposite sides of the medium, respectively, relative to the cutting axis during the blade driving.

In accordance with at least one or more additional and/or alternative embodiments, the first and second transverse axes are transverse relative to the cutting axis and the rotational axis is parallel with the first axis.

In accordance with at least one or more additional and/or alternative embodiments, the driving of the angling includes angling the opposite sides of the blade in concert to impart a flat angling to the blade at points of contact with the medium or to resist flat angling.

In accordance with at least one or more additional and/or alternative embodiments, the driving of the angling includes independently angling the opposite sides of the blade to impart a twist to the blade at points of contact with the medium or to resist twisting.

In accordance with at least one or more additional and/or alternative embodiments, the method further includes sensing relative positions of the blade and the medium in real-time and controlling the blade driving, the moving, the rotating and the driving of the angling in accordance with the relative positions of the blade and the medium and a predefined cutting pattern.

Additional features and advantages are realized through the techniques of the present disclosure. Other embodiments and aspects of the disclosure are described in detail herein and are considered a part of the claimed technical concept. For a better understanding of the disclosure with the advantages and the features, refer to the description and to the drawings.

### BRIEF DESCRIPTION OF THE DRAWINGS

For a more complete understanding of this disclosure, reference is now made to the following brief description, taken in connection with the accompanying drawings and detailed description, wherein like reference numerals represent like parts:

FIG. 1 is a perspective view of a multi-axis robotic cutting apparatus in accordance with embodiments;

FIG. 2 is a perspective view of a first drive system of the multi-axis robotic cutting apparatus of FIG. 1 in accordance with embodiments;

FIG. 3 is a perspective view of a second drive system of the multi-axis robotic cutting apparatus of FIG. 1 in accordance with embodiments;

FIG. 4 is an exploded perspective view of a driving unit of a fourth drive system of the multi-axis robotic cutting apparatus of FIG. 1 with a gear train in accordance with embodiments;

FIG. 5 is a perspective view of driving units of a fourth drive system of the multi-axis robotic cutting apparatus of FIG. 1 with telescoping arms in accordance with embodiments;

FIG. 6 is a schematic diagram illustrating a control system of the multi-axis cutting apparatus of FIG. 1 in accordance with embodiments;

FIG. 7 is a perspective view illustrating that the multi-axis robotic cutting apparatus can be installed on a vehicle and mobile in accordance with embodiments; and

FIG. 8 is a flow diagram illustrating a method of operating a multi-axis robotic cutting apparatus in accordance with embodiments.

### DETAILED DESCRIPTION

Timber fabrication is often constrained by the designs of traditional sawmills and industrial robotic systems that are either limited to linear cutting mechanisms or prohibitively expensive, complex and inaccessible for widespread use. As such, traditional sawmills tend to only be able to produce standardized components, leading to significant material waste and an inability to efficiently create non-planar or customized geometries. While robotic systems paired with CNC technologies offer enhanced capabilities, they require substantial infrastructure, specialized programming expertise and controlled environments, making them impractical for many users. Additionally, these systems often fail to address the growing demand for bespoke timber components with complex geometries, such as angular, curved, tapering, or twisted cuts, which are increasingly sought after in modern architectural and construction applications.

Accordingly, there is a need for a mobile, cost-effective and user-friendly multi-axis robotic sawmill capable of producing non-standard components directly from raw materials. Such a system would bridge the gap between material sourcing and design output, reduce material waste and democratize access to advanced fabrication technologies.

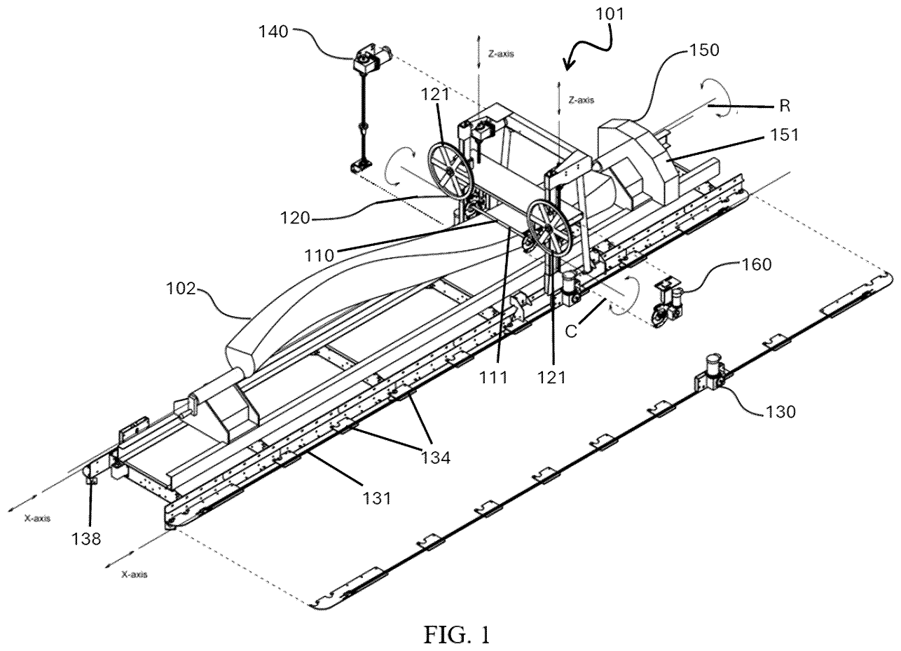

With reference to FIG. 1, a multi-axis robotic cutting apparatus 101 is provided and includes a blade 110 and a blade driver 120. The blade driver 120 is supportive of the blade 110 and configured to execute blade driving to drive the blade 110 in a cutting motion along a cutting axis C relative to a medium 102. The multi-axis robotic cutting apparatus 101 further includes a first drive system 130, a second drive system 140, a third drive system 150 and a fourth drive system 160. The first drive system 130 is configured to move at least the blade 110 in a first axis (hereinafter referred to as the “x-axis” as shown in FIG. 1) relative to the medium 102 during the blade driving. The second drive system 140 is configured to move at least the blade 110 in a second axis (hereinafter referred to as the “z-axis” as shown in FIG. 1) relative to the medium 102 during the blade driving. The third drive system 150 is configured to rotate at least the medium 102 about a rotational axis R relative to the blade 110 during the blade driving. The fourth drive system 160 is configured to angle the blade 110 relative to the cutting axis C during the blade driving. The x-axis and the z-axis can be transverse or perpendicular relative to one another and transverse or perpendicular relative to the cutting axis C. The rotational axis R can be generally parallel with the x-axis.

In accordance with embodiments, the blade 110 can be provided as a continuous bandsaw 111 and the medium 102 can include or be provided as wood or lumber or any other type of cuttable material. Indeed, it is to be understood that other embodiments exist and that the medium 102 could be any type of workpiece or material and the blade 110 can be appropriately provided for that type of workpiece or material. Nevertheless, the following description will generally relate to the case in which the blade 110 is the continuous bandsaw 111 and the medium 102 is lumber. This is being done for purposes of clarity and brevity and should not be interpreted as limited the following description or the claims in any way.

While the first and second drive systems 130 and 140 are described above as being configured to move at least the blade 110, it is to be understood that the first and second drive systems 130 and 140 can be configured to move the blade 110 and the blade driver 120 as a unit, collectively referred to as a bandsaw gantry. Similarly, while the third drive system 150 is described above as being configured to rotate at least the medium 102 relative to the blade 110, it is to be understood that the third drive system 150 can rotate at least the medium 102 relative to the bandsaw gantry.

The blade driver 120 can include first and second wheels 121 that rotate to drive the blade 110 in the cutting motion along the cutting axis C. The first and second wheels 121 can be operated to increase a tension of the blade 110 as needed for execution of the blade driving.

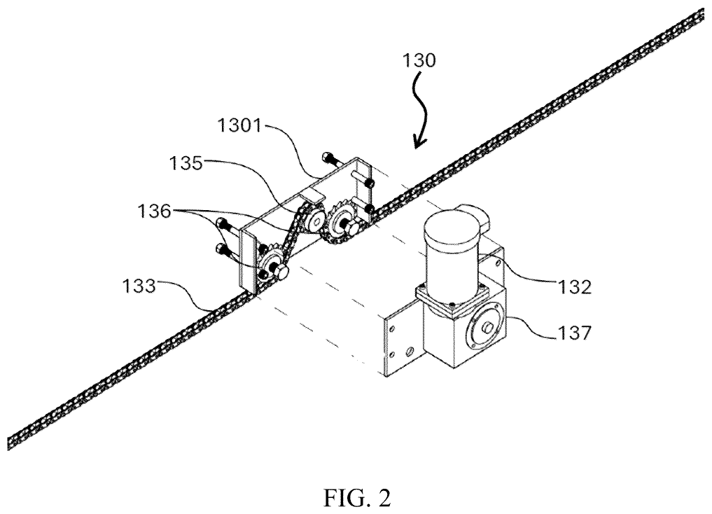

With continued reference to FIG. 1 and with additional reference to FIG. 2, at each side of the multi-axis robotic cutting apparatus 101, the first drive system 130 moves the bandsaw gantry forward and back along a support track 131. A motor 132 drives the bandsaw gantry along the track 131 via chain 133 mounted and tensioned horizontally. Projecting horizontal plates 134 provide support for the chain 133. As the bandsaw gantry moves along the x-axis, the chain 133 is lifted up and around a drive sprocket 135, with two idler sprockets 136 maintaining a rest of the chain 133 in a flat orientation. The drive sprocket 135 is powered the motor 132 and a worm gear speed reducer 137. Extensions can be added to the jack feet 138 (see FIG. 1) for ground clearance. A housing 1301 is provided to house the first drive system 130.

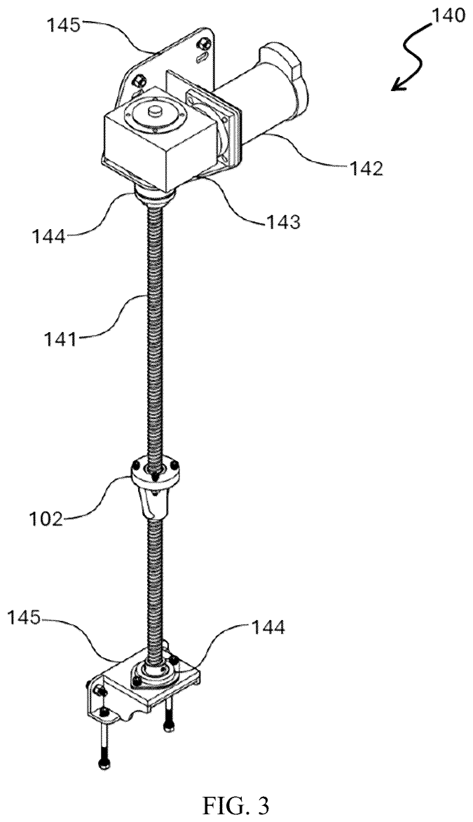

With continued reference to FIG. 1 and with additional reference to FIG. 3, the second drive system 140 controls the height of the bandsaw gantry at each side of the multi-axis robotic cutting apparatus 101 and can maintain the blade 110 in a horizontal orientation or in an angled orientation. The second drive system 140 can include vertical ball screws 141. Each vertical ball screw 141 can be driven at its top and connected via a flexible shaft coupling to an integrated servo motor 142 and a worm gear speed reducer 143. The vertical ball screws 141 can be supported at the top and bottom with thrust ball and radial ball bearings 144 in an adjustable flange mount 145. Supports at the top and bottom can be designed with slotted machine screw connections such that fine adjustments to their position can be made to properly align the vertical ball screws 141. As noted above, the vertical ball screws 141 can be operated to horizontally level the blade 110 relative to the medium.

With continued reference to FIG. 1, the third drive system 150 can include a lathe element 151 that can be modified for CNC positioning control. The lathe element 151 can include a continuous rotation electric motor and/or an integrated servo motor and a worm gear speed reducer that drives the medium 102 position via a chain and sprocket assembly.

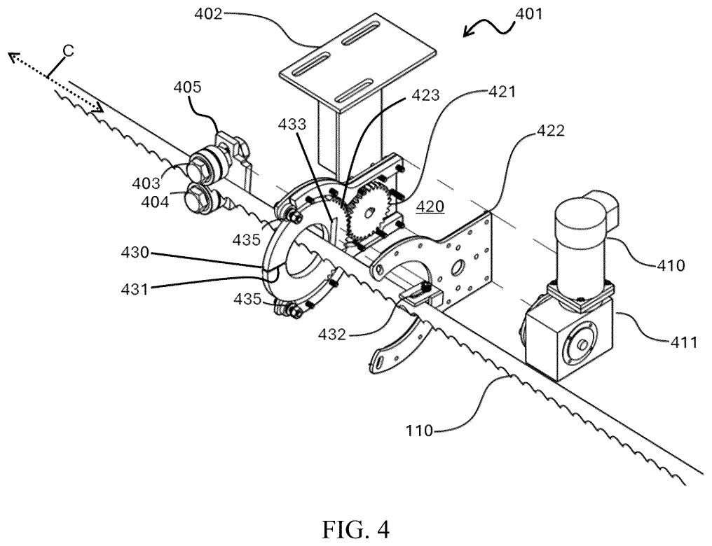

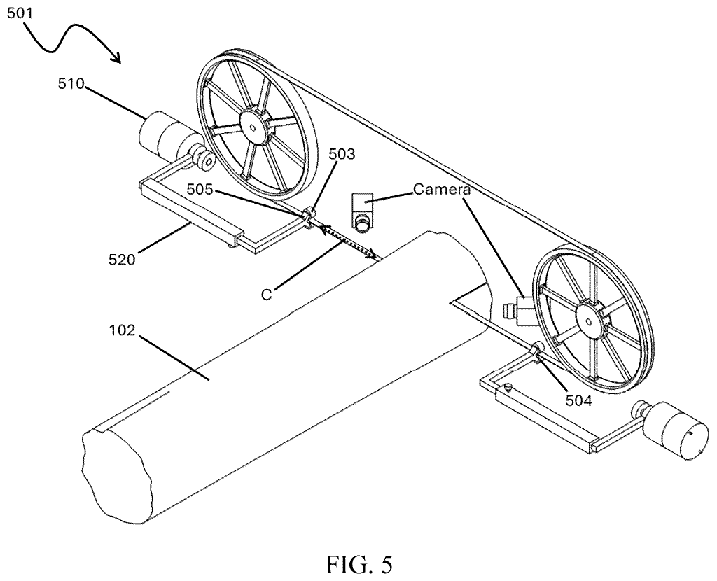

With continued reference to FIG. 1 and with additional reference to FIGS. 4 and 5, the fourth drive system 160 can be operated at opposite sides of the blade 110, which are in turn defined at opposite sides of the medium 102. The fourth drive system 160 can be configured to angle the opposite sides of the blade 110 in concert to impart a flat angling to the blade 110 at points of contact with the medium 102 or can be configured to independently angle the opposite sides of the blade 110 with respect to one another to impart a twist to the blade 110 at points of contact with the medium 102.

Importantly, the fourth drive system 160 can be configured to drive an angling of the opposite sides of the blade 110 in concert to impart the flat angling to the blade 110 at the points of contact with the medium 102 or to drive an angling of the opposite sides of the blade 110 in concert to resist imparting the flat angling to the blade 110 by the points of contact with the medium 102. Likewise, the fourth drive system 160 can be configured to drive an independent angling of the opposite sides of the blade 110 with respect to one another to impart the twist to the blade 110 at the points of contact with the medium 102 or to drive an independent angling of the opposite sides of the blade 110 with respect to one another to resist imparting the twist to the blade 110 by the points of contact with the medium 102.

As shown in FIG. 4, the fourth drive system 160 (see FIG. 1) can include a driving unit 401 at each of the opposite sides of the blade 110. Each driving unit 401 can include a mounting bracket 402 by which the driving unit 401 is connected with the multi-axis robotic cutting apparatus 101 (see FIG. 1), an upper roller bearing 403 and a lower roller bearing 404 to supportively bear upon the blade 110, a rigid member 405 to tightly urge the upper and lower roller bearings 403 and 404 against upper and lower surfaces of the blade 110, a power generating element 410 and a gear train 420. The power generating element 410 can be provided as a stepper motor and can include a right-angle worm gear speed reducer 411 and can be configured to generate torque for pivoting the rigid member 405 and the upper and lower roller bearings 403 and 404 about the cutting axis C. The gear train 420 is configured such that the torque is transferred from the power generating element 410 to the rigid member 405 and the upper and lower roller bearings 403 and 404 to pivot the rigid member 405 and the upper and lower roller bearings 403 and 404 about the cutting axis C. Each driving unit 401 can further include a hollow, C-shaped gear 430 with a first slot 431 and an adjustable bearing 432 for receiving and centering the blade 110. The hollow C-shaped gear 430 can have a second slot 433 into which the rigid member 405 is insertible. The gear train 420 includes a drive gear 421 secured in a housing 422, which is attached to the mounting bracket 402, and a gear section 423 of the hollow C-shaped gear 430. The hollow C-shaped gear 430 is supported in the housing 422 by bearings 435.

Torque generated by the power generating element 410 is transmitted to the drive gear 421, which turns the gear section 423 of the hollow C-shaped gear 430, which in turn pivots and causes the rigid member 405 and the upper and lower roller bearings 403 and 404 to pivot. The pivoting of the upper and lower roller bearings 403 and 404 causes the blade 110 to rotate about the cutting axis C.

As shown in FIG. 5, in an alternative embodiment, the fourth drive system 160 (see FIG. 1) can include a driving unit 501 at each of the opposite sides of the blade 110. Each driving unit 501 can be constructed generally similarly as described above with reference to FIG. 4 except as described below. The driving unit 501 can include a mounting bracket (see, e.g., the mounting bracket 402 of FIG. 4) by which the driving unit 501 is connected with the multi-axis robotic cutting apparatus 101 (see FIG. 1), an upper roller bearing 503 and a lower roller bearing 504 to supportively bear upon the blade 110, a rigid member 505 to tightly urge the upper and lower roller bearings 503 and 504 against upper and lower surfaces of the blade 110, a power generating element 510 and a telescopic arm 520. The power generating element 510 can be provided as a stepper motor and can include a worm gear speed reducer (see, e.g., the right-angle worm gear speed reducer 411 of FIG. 4) and can be configured to generate torque for pivoting the rigid member 505 and the upper and lower roller bearings 503 and 504 about the cutting axis C. The telescopic arm 520 is connected at opposite ends thereof to the power generating element 510 and to the rigid member 505 and the upper and lower roller bearings 503 and 504 and is configured to transfer the torque generated by the power generating element 510 from the power generating element 510 to the rigid member 505 and the upper and lower roller bearings 503 and 504 to pivot the upper and lower roller bearings 503 and 504 about the cutting axis C. The telescopic arm 520 can be further configured to telescopically extend and retract the rigid member 505 and the upper and lower roller bearings 503 and 504 toward and away from the medium 102.

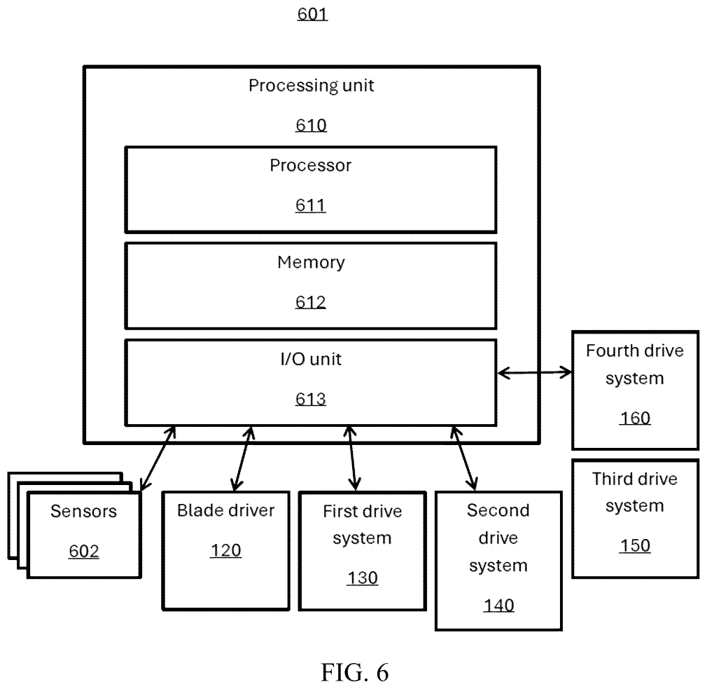

With continued reference to FIGS. 1-5 and with additional reference to FIG. 6, the multi-axis robotic cutting apparatus 101 can also include a control system 601. As shown in FIG. 6, the control system 601 includes sensors 602 (see, e.g., the cameras of FIG. 5) configured to sense relative positions of the blade 110 and the medium 102 in real-time and a processing unit 610 that is operably coupled with the sensors 602, the blade driver 120 and the first-fourth drive systems 130, 140, 150 and 160. The processing unit 610 includes a processor 611, a memory 612 and an input/output (I/O) unit 613 by which the processor 611 is communicative with the sensors 602, the blade driver 120 and the first-fourth drive systems 130, 140, 150 and 160. The memory 612 has executable instructions stored thereon which are readable and executable by the processor 611. When the executable instructions are read and executed by the processor 611, the executable instructions cause the processor 611 to operate as described herein. For example, the processor 611 can receive information relating to the relative positions of the blade 110 and the medium 102 from the sensors 602 via the I/O unit 613 and can control the blade driver 120 and the first-fourth drive systems 130, 140, 150 and 160 via the I/O unit 613 in accordance with the information and a predefined cutting pattern.

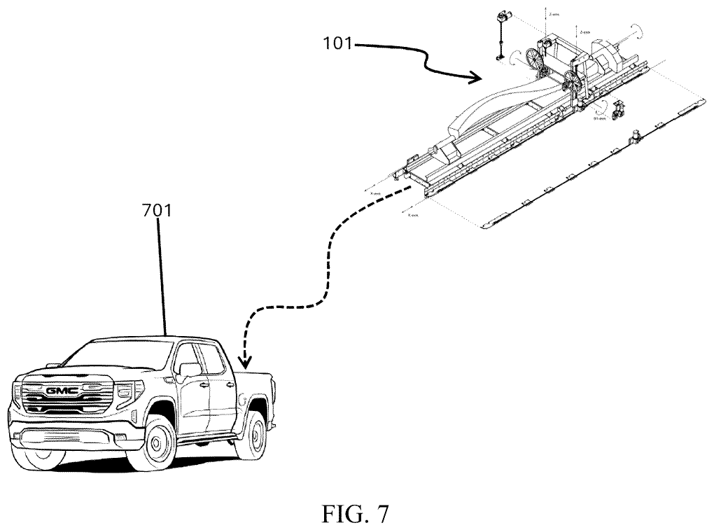

With continued reference to FIGS. 1-5 and with additional reference to FIG. 7, the multi-axis robotic cutting apparatus 101 can be relatively small and mobile and can be installed on and transported by a vehicle, such as the vehicle 701 of FIG. 7 or a towable trailer unit.

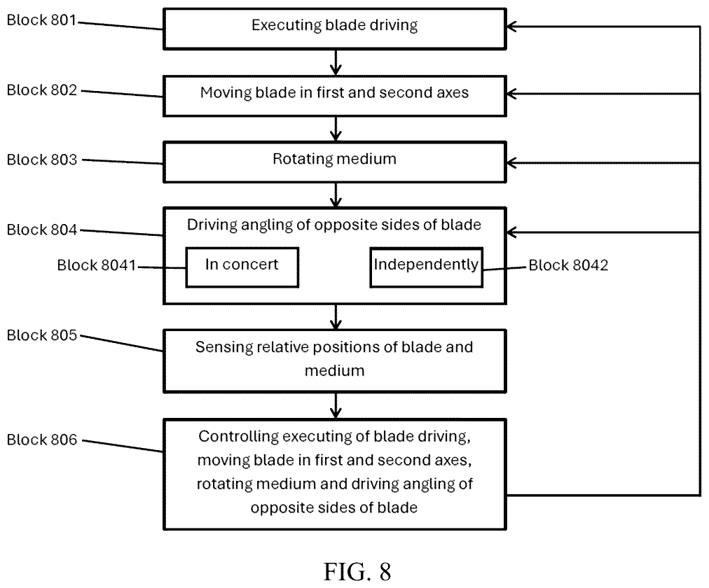

With reference to FIG. 8, a method 800 of operating a multi-axis robotic cutting apparatus, such as the multi-axis robotic cutting apparatus 101 of FIG. 1, is provided. As shown in FIG. 8, the method 800 includes executing blade driving to drive a blade in a cutting motion along a cutting axis relative to a medium (block 801), moving at least the blade in first and second transverse axes, respectively, relative to the medium during the blade driving (block 802), rotating at least the medium about a rotational axis relative to the blade during the blade driving (block 803) and driving an angling of opposite sides of the blade, which are defined at opposite sides of the medium, respectively, relative to the cutting axis during the blade driving (block 804). In addition, the method 800 can include sensing relative positions of the blade and the medium in real-time (block 805) and controlling the blade driving of block 801, the moving of block 802, the rotating of block 803 and the driving of the angling of block 804 in accordance with the relative positions of the blade and the medium and a predefined cutting pattern (block 806). As above, the first and second transverse axes are transverse or perpendicular relative to the cutting axis and the rotational axis is parallel with the first axis. In accordance with embodiments, the driving of the angling of block 804 can include angling the opposite sides of the blade in concert to impart a flat angling to the blade at points of contact with the medium or to resist flat angling caused by contact with the medium (block 8041) and/or independently angling the opposite sides of the blade to impart a twist to the blade at points of contact with the medium or to resist twisting caused by the medium (block 8042).

Technical effects and benefits of the present disclosure are the provision of a relatively small and mobile multi-axis robotic cutting apparatus that allows for optimized and customized cutting operations with reduced waste and that has the capability of angling its blade to be angled flatly or to resist such flat angling or to be twisted during the cutting process or to resist such twisting.

The corresponding structures, materials, acts and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the technical concepts in the form disclosed. Many modifications and variations will be apparent to those of ordinary skill in the art without departing from the scope and spirit of the disclosure. The embodiments were chosen and described in order to best explain the principles of the disclosure and the practical application and to enable others of ordinary skill in the art to understand the disclosure for various embodiments with various modifications as are suited to the particular use contemplated.

While the preferred embodiments to the disclosure have been described, it will be understood that those skilled in the art, both now and in the future, may make various improvements and enhancements which fall within the scope of the claims which follow. These claims should be construed to maintain the proper protection for the disclosure first described.

What is claimed is:

1. A multi-axis robotic cutting apparatus, comprising:
a blade;
a blade driver supportive of the blade to execute blade driving to drive the blade in a cutting motion along a cutting axis relative to a medium;
first and second drive systems to move at least the blade in first and second transverse axes, respectively, relative to the medium during the blade driving;
a third drive system to rotate at least the medium about a rotational axis relative to the blade during the blade driving; and
a fourth drive system to drive an angling of the blade relative to the cutting axis during the blade driving.

2. The multi-axis robotic cutting apparatus according to claim 1, wherein the blade is a continuous bandsaw and the medium is wood or lumber.

3. The multi-axis robotic cutting apparatus according to claim 1, wherein the first and second transverse axes are transverse relative to the cutting axis and the rotational axis is parallel with the first axis.

4. The multi-axis robotic cutting apparatus according to claim 1, wherein:
opposite sides of the blade are defined at opposite sides of the medium, respectively, and
the fourth drive system drives an angling of the opposite sides of the blade in concert to impart a flat angling to the blade at points of contact with the medium or drives the angling of the opposite sides of the blade to resist imparting the flat angling to the blade at the points of contact with the medium.

5. The multi-axis robotic cutting apparatus according to claim 1, wherein:
opposite sides of the blade are defined at opposite sides of the medium, respectively, and
the fourth drive system drives an independent angling of the opposite sides of the blade to impart a twist to the blade at points of contact with the medium or drives the independent angling of the opposite sides of the blade to resist imparting the twist to the blade at the points of contact with the medium.

6. The multi-axis robotic cutting apparatus according to claim 1, wherein:
opposite sides of the blade are defined at opposite sides of the medium, respectively, and
the fourth drive system comprises driving units at each of the opposite sides of the blade and each of the driving units comprises:
a set of bearings to supportively bear upon the blade;
a power generating element to generate torque for pivoting the set of bearings about the cutting axis; and
a gear train by which the torque is transferred from the power generating element to the set of bearings to pivot the bearings about the cutting axis.

7. The multi-axis robotic cutting apparatus according to claim 1, wherein:
opposite sides of the blade are defined at opposite sides of the medium, respectively, and
the fourth drive system comprises driving units at each of the opposite sides of the blade and each of the driving units comprises:
a set of bearings to supportively bear upon the blade;
a power generating element to generate torque for pivoting the set of bearings about the cutting axis; and
a telescopic arm connected at opposite ends thereof to the power generating element and the set of bearings and by which the torque is transferred from the power generating element to the set of bearings to pivot the bearings about the cutting axis.

8. The multi-axis robotic cutting apparatus according to claim 7, wherein the telescopic arm is configured to telescopically extend and retract the bearings toward and away from the medium.

9. The multi-axis robotic cutting apparatus according to claim 1, further comprising a control system, the control system comprising:
sensors configured to sense relative positions of the blade and the medium in real-time; and
a processing unit operably coupled with the sensors, the blade driver and the first-fourth drive systems,
the processing unit being configured to receive information relating to the relative positions of the blade and the medium from the sensors and to control the blade driver and the first-fourth drive systems in accordance with the information and a predefined cutting pattern.

10. A drive system for controlling a blade of a multi-axis robotic cutting apparatus, the drive system comprising:
driving units at opposite sides of the blade defined along a cutting axis thereof, each driving unit comprising:
a mounting bracket by which the driving unit is connected with the multi-axis robotic cutting apparatus;
upper and lower roller bearings;
a rigid member to tightly urge the upper and lower roller bearings against upper and lower surfaces of the blade, respectively; and
a power generating element to generate torque for pivoting the rigid member and the upper and lower roller bearings about the cutting axis and relative to the mounting bracket.

11. The drive system according to claim 10, wherein the blade is a continuous bandsaw.

12. The drive system according to claim 10, wherein each driving unit further comprises a hollow, C-shaped gear with a slot and an adjustable bearing for receiving and centering the blade.

13. The drive system according to claim 10, wherein each driving unit further comprises a gear train by which the torque is transferred from the power generating element to the rigid member and the upper and lower roller bearings.

14. The drive system according to claim 10, wherein each driving unit further comprises a telescopic arm connected at opposite ends thereof to the power generating element and the rigid member and by which the torque is transferred from the power generating element to the rigid member and the upper and lower roller bearings.

15. The drive system according to claim 14, wherein the telescopic arm is configured to telescopically extend and retract the rigid member and the upper and lower roller bearings along the cutting axis.

16. A method of operating a multi-axis robotic cutting apparatus, the method comprising:
executing blade driving to drive a blade in a cutting motion along a cutting axis relative to a medium;
moving at least the blade in first and second transverse axes, respectively, relative to the medium during the blade driving;
rotating at least the medium about a rotational axis relative to the blade during the blade driving; and
driving an angling of opposite sides of the blade, which are defined at opposite sides of the medium, respectively, relative to the cutting axis during the blade driving.

17. The method according to claim 16, wherein the first and second transverse axes are transverse relative to the cutting axis and the rotational axis is parallel with the first axis.

18. The method according to claim 16, wherein the driving of the angling comprises angling the opposite sides of the blade in concert to impart a flat angling to the blade at points of contact with the medium or to resist flat angling.

19. The method according to claim 16, wherein the driving of the angling comprises independently angling the opposite sides of the blade to impart a twist to the blade at points of contact with the medium or to resist twisting.

20. The method according to claim 16, further comprising:
sensing relative positions of the blade and the medium in real-time; and
controlling the blade driving, the moving, the rotating and the driving of the angling in accordance with the relative positions of the blade and the medium and a predefined cutting pattern.
